(19) United States
(12) Patent Application Publication
(10) Pub. No.: US 2012/0259546 A1
(43) Pub. Date: Oct. 11, 2012

(54) APPARATUS AND METHOD FOR DISPLAYING ROAD GUIDE INFORMATION ON WINDSHIELD

(75) Inventor: Ju Nam Kim, Gyeonggi-do (KR)

(73) Assignee: HYUNDAI MOTOR COMPANY, Seoul (KR)

(21) Appl. No.: 13/240,561

(22) Filed: Sep. 22, 2011

(30) Foreign Application Priority Data
Apr. 5, 2011 (KR) 10-2011-0031352

(51) Int. Cl. G01C 21/36

(52) U.S. Cl. 701/527

(57) ABSTRACT

An apparatus for displaying road guidance information on a windshield that enables a driver to accurately recognize a road associated with a destination route by overlaying road guide information of a navigation system on the actual road based on an eye location of a driver by displaying mapped results on a windshield of a vehicle in variable location, and a method thereof are provided.

### CROSS-REFERENCES TO RELATED APPLICATIONS

Priority to Korean patent application number 10-2011-0031352, filed on Apr. 5, 2011, which is hereby incorporated by reference in its entirety, is claimed.

### BACKGROUND OF THE INVENTION

1. Field of the Invention

The present invention relates to an apparatus and a method for displaying road guide information on a windshield, and more particularly, to an apparatus for displaying road guide information on a windshield that maps road guide information of a navigation system to a actual road based on an eye location of a driver and displays mapped results on a windshield of a vehicle, and a method thereof.

2. Description of the Related Art

Telematics terminals are typically mounted vehicles, and provide telephone functions, map information, multimedia information, and a Global Positioning System (GPS) navigation functions to a user through a wireless communication network. A vehicle navigation system installed in the telematics terminal provides a plurality of map pages indicating a location of a vehicle to the user based on GPS signals and map information. Since a conventional vehicle navigation system displays a road guide map on a display unit of the telematics terminal, a driver must compare the road guide map displayed on the display unit of the telematics terminal with the actual road during turn in the route guidance.

For example, because the driver checks the actual road (e.g., at complicated crossroad) through the front windshield of a vehicle and a road indicated on a road guide map displayed on the display unit of the telematics terminal during turn and compares the actual road with the road on the road guide map, it may be difficult for the driver to exactly recognize which route correlates with turn on the display unit.

### SUMMARY OF THE INVENTION

The present invention provides an apparatus for displaying road guide information on a windshield that enables a driver to overlay and recognize a road associated with a destination by mapping road guide information of a navigation system to an actual road based on an eye location of a driver and displaying mapped results on a windshield of a vehicle, and a method thereof.

In accordance with an aspect of the present invention, an apparatus for displaying road guide information on a windshield, includes: a navigation associating means acquiring road guide information to a destination set by a driver; a front image recognition means recognizing a travel lane from a front road image; an eye location detecting means detecting an eye location from a facial image of the driver; a control means controlling a windshield display means to map the road guide information to the actual road on the windshield based on the eye location of the driver detected by the eye location detecting means and display a mapped result; and the windshield display means mapping the road guide information to the actual road and displaying the mapped result under control of the control means.

In accordance with another aspect of the present invention, a method for displaying road guide information on a windshield, includes: acquiring road guide information to a destination set by a driver associated with a navigation system of a vehicle; recognizing a front road image; detecting an eye location from a facial image of the driver; and mapping the road guide information to a actual road on the windshield based on the detected eye location of the driver.

The present invention illustrated above maps road guide information of a navigation system to an actual road based on an eye location of a user to display the mapped result on a windshield of a vehicle, such that the driver may exactly recognize a road associated with the destination.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating an apparatus for displaying road guide information on a windshield according to an exemplary embodiment of the present invention;

FIG. 2 is a view illustrating a procedure of recognizing a curved road according to an exemplary embodiment of the present invention;

FIG. 3 is a view illustrating a procedure of detecting an eyes location of a driver according to an exemplary embodiment of the present invention;

FIG. 4 is a view illustrating a procedure mapping road guide information on an actual road according to an exemplary embodiment of the present invention;

FIG. 5 is a view illustrating an example of a state that road guide information is mapped on an actual road according to an exemplary embodiment of the present invention; and

FIG. 6 is a flowchart illustrating a method for displaying road guide information on a windshield according an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

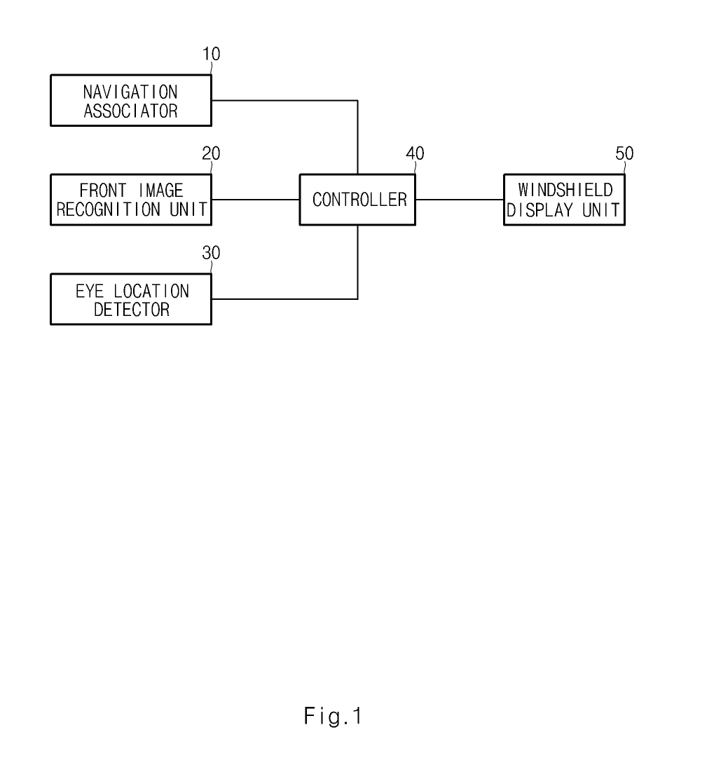

FIG. 1 is a block diagram illustrating an apparatus for displaying road guide information on a windshield according to an exemplary embodiment of the present invention.

Referring to FIG. 1, the apparatus for displaying road guide information on a windshield according to an exemplary embodiment of the present invention includes a navigation associator 10, a front image recognition unit 20, an eye location detector 30, a controller 40, and a windshield display unit 50.

The following is a detailed description of the respective structural elements. The navigation interworking unit (associator) 10 acquires road guidance information for routing the driver to a destination set by a driver within a navigation system. The front image recognition unit 20 recognizes a travel lane and an end point of a road from a front image of a traveling road photographed by, e.g., a camera mounted on a front part of a vehicle. The front image recognition unit 20 is configured to recognize a travel lane in conjunction with a lane keeping assistance system or a lane departure warning system mounted within the vehicle. These systems are systems are a mechanisms designed to warn or assist a driver when the vehicle begins to move out of its lane on freeways and roads.

The vehicle may recognize the travel lane to provide exact road guidance information to a driver. For example, when the vehicle is coming up on an interchange located on the right side of a lane (third lane) three lanes over from the lane the vehicle is currently travelling (first lane) in, and lane recognition is impossible, only a straight direction route guidance from a first lane to a third lane interchange is possible. However, if lane recognition is possible, a lane change may be induced at a suitable location to change the lanes to the first lane, a second lane, or the third lane.

The eye location detector 30 detects a driver's eye location from a facial image of the driver photographed by a camera mounted in the vehicle. The controller 40 maps road guidance information acquired by the navigation associator 10 to the actual road and displays the mapped result on the display unit 50. In this case, Electronic Control Units (ECU) of the vehicle may perform the function of the controller 40.

Accordingly, the present invention may map the road guide information to an actual road suitable for a driver regardless of the driver's eye location. Consequently, since the driver may receive route guidance to a destination while viewing the road guide information displayed and mapped to the actual road, the drive may safely travel to the destination without being hindered due to an unnecessarily taking their eyes off the road.

The windshield display unit 50 maps the road guide information to the actual road and displays the mapped result under the control of the controller 40. At this time, the windshield display unit 50 may include a Head Up Display (HUD) device, a projection device, a transparent windshield display device, or a windshield dot display device.

Alternatively, the present invention may also include an eye location information acquiring unit 30 instead of the eye location detector 30, and may acquire eye location information of a driver associated with a driver monitoring system or an eye tracking system mounted within the vehicle.

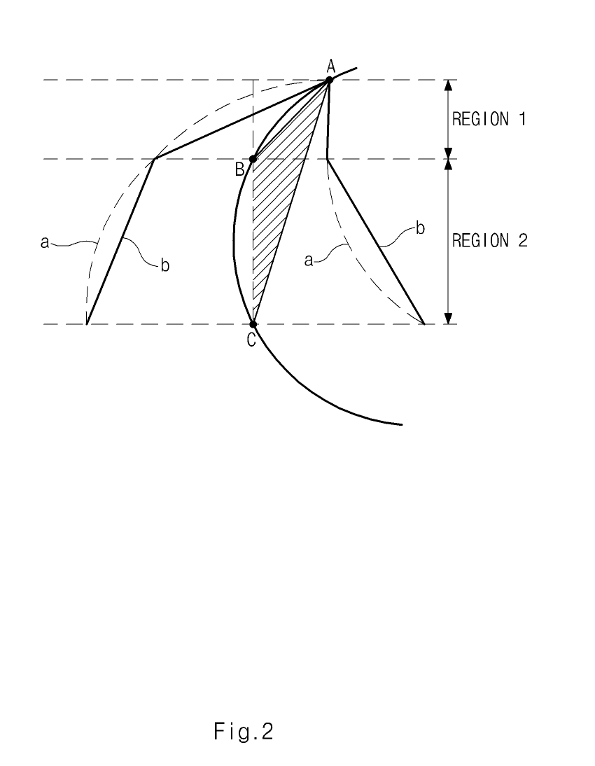

A procedure recognizing a curved road by a front image recognition unit 20 will be described with reference to FIG. 2. In this case, recognition of a straight lane is well-known prior art, and thus a detailed description is omitted. The front image recognition unit 20 includes a camera, an image processor, a preprocessor, and a curvature calculator. The camera is a Charge-Coupled Device (CCD) camera capable of photographing digital images in real-time, for photographing a road image. The image processor divides a road image photographed by the camera into two regions. For example, the road image may be divided into an upper region and a lower region. The divided image processing regions are called a region 1 and a region 2 as shown in FIG. 2, respectively.

Next, a preprocessor may perform lane modeling into one dimensional straight line with respect to the two regions. In this case, the lane modeling refers to a procedure that detects an edge component a of a road image in a region 1 and a region 2 and calculates a straight line b connecting respective points of the detected edge component to each other.

Further, the preprocessor selects a triangle formed by respectively modeled lines. As shown in FIG. 2, the preprocessor selects center points B and C and a vanishing point A of cross points of respective modeled straight lines B in the region 1 and the region 2 as an extreme point. Further, the preprocessor calculates a circumscribed radius of the selected triangle. In this case, the circumscribed radius R of the selected triangle is uniquely determined, which may be expressed by a following equation 1.

$$R = \frac{Len ( AB ) \times Len ( BC ) \times Len ( A C )}{4 S} \qquad [ Equation 1 ]$$

where, AB, BC, and AC are line segments formed by respective points, Len (AB) is the length of a line x, and S is an area of a triangle ABC.

A curvature calculator calculates a curvature of a road using the calculated circumscribed radius R from the preprocessor. The curvature becomes an inverse number of the circumscribed radius R. Accordingly, the front image recognition unit 20 may recognize a curved road through this procedure.

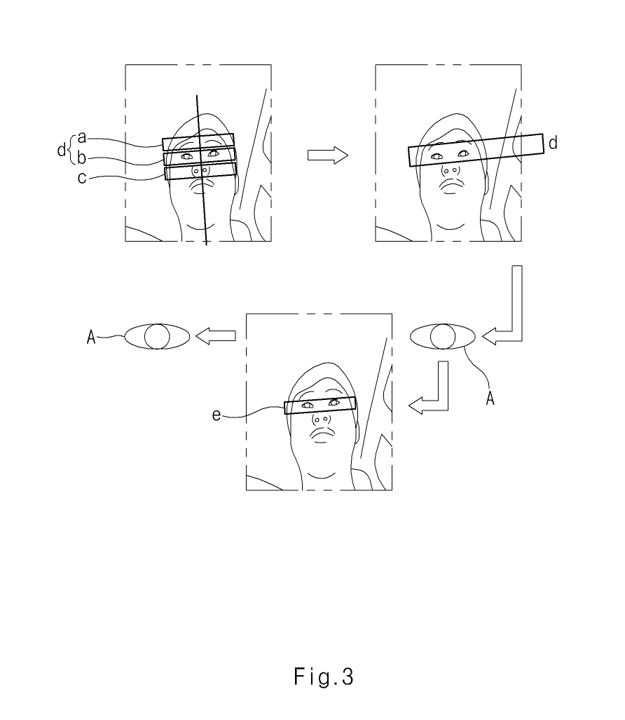

A procedure detecting an eye location by the eye location detector 30 will be explained with reference to FIG. 3 in detail.

The eye location detector 30 concentrates and tests a symmetrical part of a face, namely, a first symmetrical point region (a) being an eye brow part, a second symmetrical point region (b) being an eye part, and a third symmetrical point region (c) being a nose hole from a facial image of a driver photographed by a camera (e.g., CCD camera) to detect a symmetrical point for a determination reference in consideration of a shape, the size, a distance, and brightness. At this time, the eye location detector 30 sets a third symmetrical point region (c) as a reference point for determination. This uses the fact that has few variations in brightness as compared with other parts and is located at the lowest position buts forms a symmetrical part of a short interval.

Next, a third symmetrical region (c) having a nose hole is set as a symmetrical point for a determination reference from the facial image, and then an upper part of the third symmetrical region (c) is set as an eye location candidate region d (namely, first and second symmetrical regions a and b).

As described above, after setting an eye location candidate region (d) in the facial image, an eye location is concentrated and tested in the eye location candidate region (d) using a filter (e.g., a Sobel filter). This is because a load may be significantly applied to concentrate and display a contour using the filter (e.g., a Sobel filter).

Subsequently, an eye location determination region (e) is selected through a filter image with respect to the eye location candidate region (d). In this case, an eye location determination region (e) comprises a first eye shape A having a contour of an elliptical shape. That is, the eye location detector 30 detects an eye location.

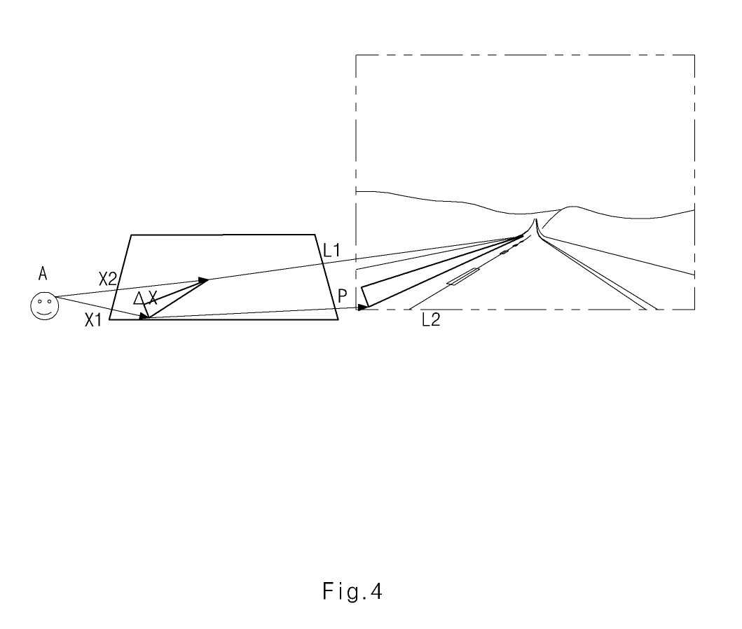

Next, a mapping procedure by the controller 40 will be described with reference to FIG. 4 in detail. FIG. 4 is a view illustrating a procedure mapping road guidance information on an actual road according to an embodiment of the present invention.

Referring to FIG. 4, P is a traveling road, L1 is a left lane of a traveling road, L2 is a right lane of a traveling road, A is an eye location of a driver, x1 is a vector from current eyes of the driver to a windshield, and x2 is a vector from an eye of the driver to the windshield after predetermined time Δt.

First, a driver recognizes road information (n-th lane) where a vehicle is located through L1, L2, and P. At this time, the front image recognition unit 20 may recognize a lane change through lane information related to a road. Next, an x value is calculated using A and P. Since the windshield is fixed, a corresponding vector may be projected on a windshield plane to recognize a location to be displayed on the windshield.

Further, an equation related to the windshield plane changes according to calculation results of a direction vector in which a vehicle faces through, for example, a gyro sensor or a yaw rate sensor. That is, although a travel direction is the same, a direction in which the vehicle faces changes. Thus, mapping without compatibility issues is possible in the same direction as the driver's destination. To do so, logic is used to enable the same mapping operation via a hologram image mounted on a vehicle hood as well as a windshield. Subsequently, ΔP, ΔL1, and ΔL2 are computed after Δt using GPS information acquired through the navigation associator 10. Δt this time, because a driver knows the distance to a junction based on the GPS information provided, the driver compares the distance to ΔL1 with a distance ΔL2 to make possible error corrections.

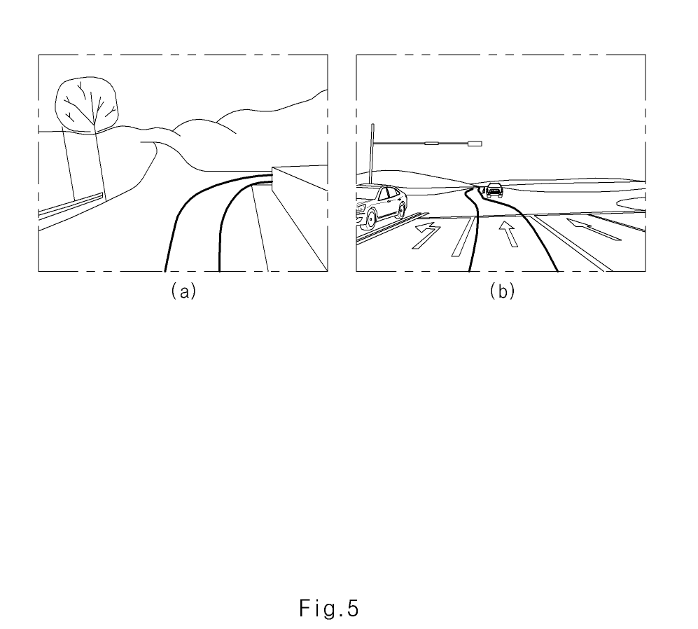

Next, x2 is calculated using ΔP, ΔL1, and ΔL2. As a result, when repeating the predetermined number of the foregoing procedure, as shown in FIG. 5, road guidance information may be mapped to overlay an actual road on the windshield and the mapped result displayed.

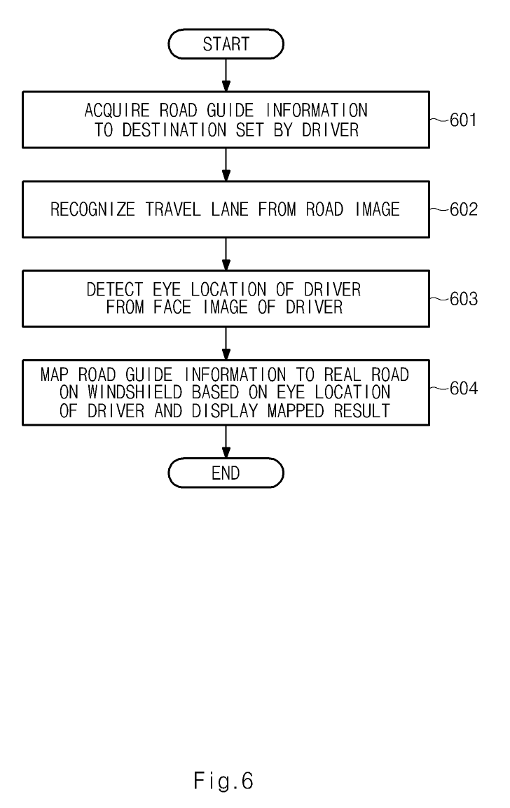

FIG. 6 is a flowchart illustrating a method for displaying road guide information on a windshield according an exemplary embodiment of the present invention. First, a navigation associator 10 acquires road guidance information to a destination set by a driver associated with a navigation system of a vehicle (601). Next, a front image recognition unit 20 recognizes a travel lane from a road image (602) and executes a detailed road guidance function and an error correction function. Subsequently, an eye location detector 30 detects the eye location of a driver from a facial image of the driver photographed by a camera (603).

Next, the controller 40 maps the road guidance information to overlay the actual road on a windshield based on an eye location of a driver detected by the eye location detector 30, and displays the mapped result on the display unit 150 (604).

Furthermore, the present invention may be embodied as non-transitory computer readable media on a computer readable medium containing executable program instructions executed by a processor. Examples of the computer readable mediums include, but are not limited to, ROM, RAM, compact disc (CD)-ROMs, magnetic tapes, floppy disks, and optical data storage devices. The computer readable recording medium can also be distributed in network coupled computer systems so that the computer readable media is stored and executed in a distributed fashion.

Through the foregoing procedures, the driver may see exactly where he or she is supposed to go without having to take their eyes off the road.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. An apparatus for displaying road guidance information on a windshield, the apparatus comprising:
a navigation associating means acquiring road guidance information to a destination set by a driver;
a front image recognition means recognizing a travel lane from a front road image;
an eye location detecting means detecting an eye location from a facial image of the driver;
a control means controlling a windshield display means to map the road guidance information to overlay an actual road on the windshield based on the eye location of the driver detected by the eye location detecting means and display a mapped result; and
the windshield display means mapping the road guidance information to overlay the actual road and displaying the mapped result under control of the control means.

2. The apparatus of claim 1, wherein the front image recognition means comprises:
a camera photographing the road image;
an image processor dividing the road image photographed by the camera into two regions;
a preprocessor performing lane modeling into a one dimensional straight line with respect to the two regions divided by the image processor, selecting a triangle formed by respective modeled lines, and calculating a circumscribed radius of the selected triangle; and
a curvature calculator calculating a curvature of a road using the circumscribed radius of the selected triangle calculated by the preprocessor.

3. The apparatus of claim 1, wherein the eye location detecting means selects a region for a symmetrical part of a face from a facial image of the driver, selects an upper part of a noise hole as an eye location candidate region in which an eye is located by using the nose hole among a symmetrical point displayed on the fact image as a determination reference, and filters the eye location candidate region selected from the facial image by a filter to detect an eye location.

4. The apparatus of claim 3, wherein a region for the symmetrical part of a face is an eye brow part, an eye part, or a noise hole part.

5. The apparatus of claim 4, wherein the nose hole part is selected as a determination reference of a symmetrical point using the fact that has few variations in brightness as compared with other parts and is located at the lowest position buts forms a symmetrical part of a short interval.

6. The apparatus of claim 3, wherein the filter is a sobel filter.

7. The apparatus of claim 1, wherein the windshield display means is one of a Head Up Display (HUD) device, a projection device, a transparent windshield display device, or a windshield dot display device.

8. A method for displaying road guide information on a windshield, the method comprising:
acquiring road guidance information to a destination set by a driver associated with a navigation system of a vehicle;
recognizing a front road image;
detecting an eye location from a facial image of the driver; and
mapping the road guidance information to overlay an actual road on the windshield based on the detected eye location of the driver.

9. The method of claim 8, wherein detecting an eye location comprises:
selecting a region for a symmetrical part of a face from the facial image of the driver;
selecting an upper part of a noise hole as an eye location candidate region in which an eye is located by using the nose hole among a symmetrical point displayed on the fact image as a determination reference; and
filtering the eye location candidate region selected form the facial image to detect a contour of an eye.

10. A non-transitory computer readable medium containing executable program instructions executed by a processor to for display road guide information on a windshield, comprising:
program instructions that acquire road guidance information to a destination set by a driver associated with a navigation system of a vehicle;
program instructions that recognize a frontal road image;
program instructions that detect an eye location from a facial image of the driver; and
program instructions that map the road guidance information and overlay the mapped road guidance information on an actual road on the windshield based on the detected eye location of the driver.

11. The non-transitory computer readable medium of claim 10, wherein the program instructions that detect an eye location comprise:
program instructions that select a region for a symmetrical part of a face from the facial image of the driver;
program instructions that select an upper part of a noise hole as an eye location candidate region in which an eye is located by using the nose hole among a symmetrical point displayed on the fact image as a determination reference; and
program instructions that filter the eye location candidate region selected form the facial image to detect a contour of an eye.
